(19) United States
(12) Patent Application Publication
(10) Pub. No.: US 2016/0150010 A1
(43) Pub. Date: May 26, 2016

(54) INFORMATION PROCESSING APPARATUS, DATA SAVE METHOD, AND INFORMATION PROCESSING SYSTEM

(71) Applicant: FUJITSU LIMITED, Kawasaki-shi, Kanagawa (JP)

(72) Inventor: Masaaki TAKASE, Yokohama (JP)

(21) Appl. No.: 14/873,608

(22) Filed: Oct. 2, 2015

(30) Foreign Application Priority Data
Nov. 26, 2014 (JP) 2014-239251

(51) Int. Cl. H04L 29/08; G06F 3/06

(52) U.S. Cl. CPC H04L 67/1095; H04L 67/1097; G06F 3/0619; G06F 3/061; G06F 3/065; G06F 3/0652; G06F 3/067

(57) ABSTRACT

An information processing apparatus includes a memory; and a processor coupled to the memory and configured to: receive first data from a client device; determine whether the information processing apparatus is a master device that is to store the first data, by referring to assignment information indicating a correspondence relationship between a range of a hash value and a storage destination; store the first data when it is determined that the information processing apparatus is the master device; identify a replica device that is to store a replica of the first data; transmit the replica of the first data to the identified replica device; identify a first information processing device used as the master device when it is determined that the information processing apparatus is not the master device; transmit the first data to the identified first information processing device; and store the replica of the first data.

### CROSS-REFERENCE TO RELATED APPLICATION

This application is based upon and claims the benefit of priority of the prior Japanese Patent Application No. 2014-239251, filed on Nov. 26, 2014, the entire contents of which are incorporated herein by reference.

### FIELD

The embodiment discussed herein is related to an information processing apparatus, a data save method, and an information processing system.

### BACKGROUND

In a distributed data store implemented by a plurality of servers, replicas of data accepted from a client terminal (hereinafter referred to as an object) are created in order to increase the availability of the system. For example, Japanese Laid-open Patent Publication No. 2005-339411 discloses a system including a master computer and replica computers. The master computer handles original data and replica computers handle replicas of the original data. Japanese Laid-open Patent Publication No. 2000-284998 discloses a system including a master site and replica sites and saves data so as to distribute the data across the master site and the replica sites.

Within the distributed data store, objects are transferred from one server to another when an object is saved, when an object is updated, when an object is referred to, or the like. Accordingly, if the number of objects transferred between servers may be reduced, processing of a server is speeded up. This may improve the performance of a distributed data store. However, in the above documents, attention is not paid to the traffic between servers in the distributed data store.

### SUMMARY

According to an aspect of the invention, an information processing apparatus coupled to a plurality of computers, the information processing apparatus includes a memory; and a processor coupled to the memory and configured to: receive first data from a client device; determine whether the information processing apparatus is a master device that is to store the first data, by referring to assignment information indicating a correspondence relationship between a range of a hash value and a storage destination, using a hash value of the first data computed from an identifier of the first data as a key; store the first data when it is determined that the information processing apparatus is the master device; identify a replica device that is to store a replica of the first data from among the plurality of computers; transmit the replica of the first data to the identified replica device; identify a first information processing device used as the master device from among the plurality of computers, when it is determined that the information processing apparatus is not the master device; transmit the first data to the identified first information processing device; and store the replica of the first data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a distributed data store utilizing a hash technique;

FIG. 2 is a diagram for illustrating an outline of the present embodiment;

FIG. 3 is a diagram illustrating a system outline of the present embodiment;

FIG. 4 is a functional block diagram of a server;

FIG. 5 is a diagram depicting an example of a master table stored in a master table storage unit;

FIG. 6 is a diagram depicting an example of a replica table stored in a replica table storage unit;

FIG. 7 is a diagram illustrating a main process flow;

FIG. 8 is a diagram depicting an example of a message;

FIG. 9 is a diagram illustrating a process flow of a save process;

FIG. 10 is a diagram depicting an example of a message;

FIG. 11 is a diagram illustrating a process flow of a save process;

FIG. 12 is a diagram illustrating a process flow of a reference process;

FIG. 13 is a diagram illustrating a process flow of an update process;

FIG. 14 is a diagram illustrating a process flow of the update process;

FIG. 15 is a diagram illustrating a process flow of a deletion process;

FIG. 16 is a diagram illustrating a process flow of the deletion process;

FIG. 17 is a sequence diagram illustrating an example of processing for a save request;

FIG. 18 is a sequence diagram illustrating an example of processing for a reference request;

FIG. 19 is a sequence diagram illustrating an example of processing for an update request;

FIG. 20 is a sequence diagram illustrating an example of processing for a delete request; and

FIG. 21 is a functional block diagram of a computer.

### DESCRIPTION OF EMBODIMENT

First, the outline of the present embodiment will be described. In the present embodiment, a hash technique is utilized as a method for determining the destination for saving an object. As the hash technique, for example, a consistent hashing method and the like are well known. With the hash technique, if the number of objects increases, it is possible to suppress an increase in the size of data indicating the correspondence relationship between objects and the save destinations. Furthermore, the correspondence relationship between objects and the save destinations no longer has to be changed frequently.

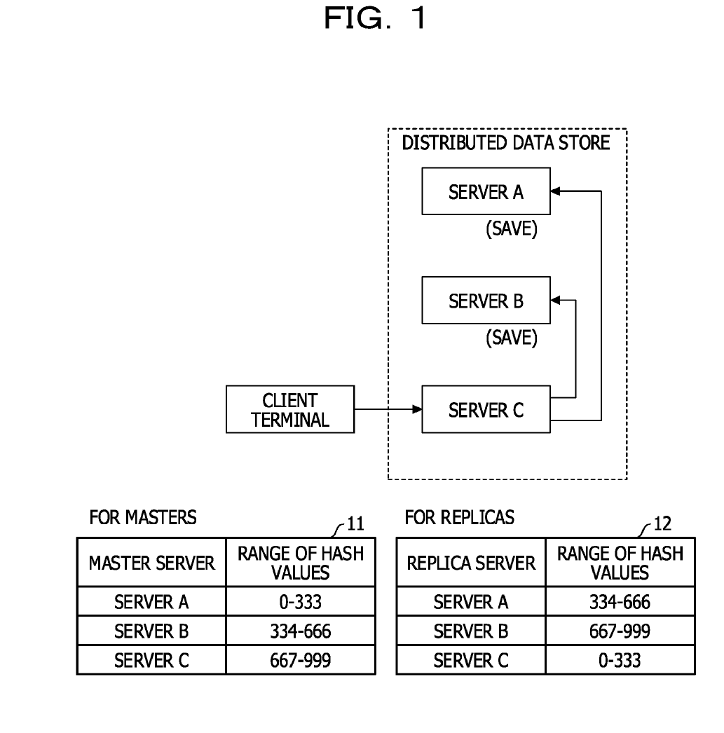

In conjunction with FIG. 1, a distributed data store using a hash technique will be described. As illustrated in FIG. 1, a distributed data store is implemented by servers A to C. Each server manages a table 11 for identifying a server in which the master of an object is to be stored (hereinafter referred to as a master server) and a table 12 for identifying a server in which a replica of an object is to be stored (hereinafter referred to as a replica server). The server C, upon accepting a request for saving an object from a client terminal, identifies a master server and a replica server using a hash value computed from the identifier (ID) of the object for which the request has been accepted, the table for masters (hereinafter referred to as a master table) 11, and the table for replicas (hereinafter referred to as a replica table) 12. Assuming that the computed hash value is 400, the master is transferred to the server B and the replica is transferred to the server A.

In this case, the number of times the object is transferred is two. If either of the destination for saving a master or the destination for saving a replica is the server C, the number of times the object is transferred is one. However, because of the properties of a hash technique, it is not possible to arbitrarily set a server serving as the save destination. Consequently, in the distributed data store illustrated in FIG. 1, the number of times an object is transferred is increased, and, as a result, the traffic among servers is increased.

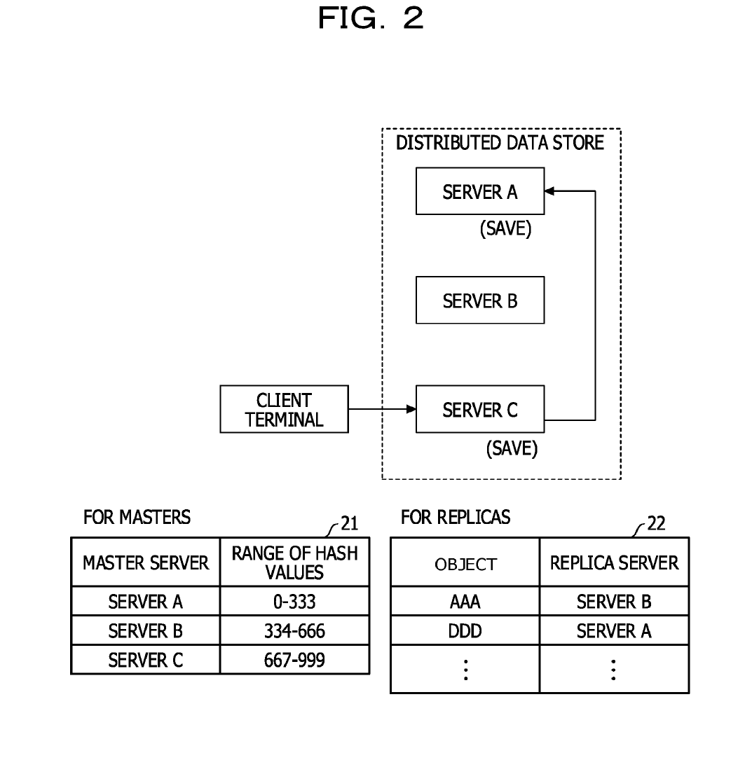

In such a situation, in the present embodiment, an object is saved as illustrated in FIG. 2. In FIG. 2, a distributed data store is implemented by the servers A to C. Each server manages a table 21 for identifying a master server and a table 22 for identifying a replica server (here being a server that is to store a replica of an object saved by that server). The contents of the table 22 differ for each server.

The server C, upon accepting a request for saving an object from a client terminal, identifies a server that is to store the master, using a hash value computed from the ID of the accepted object and the master table 21.

Assuming that the computed hash value is 300, the master is transferred to the server A. Here, the server C stores a replica of the object in a storage device of the server C. That is, the server C serves as a replica server.

Assuming that the computed hash value is 800, the master is stored in the server C. Here, the server C identifies a replica server in a given way (for example, at random from among servers other than the server C) and transmits a replica of the object to the replica server. Then, the server C stores the ID of the replica server, in association with the ID of the object, in the table 22.

In this way, if the server that has accepted a request for saving an object is a master server, the object is transmitted only to a replica server, whereas, if the server that has accepted a request for saving an object is not a master server, the object is transmitted only to a master server. This results in a decrease in the number of times an object is transferred as compared to the example illustrated in FIG. 1.

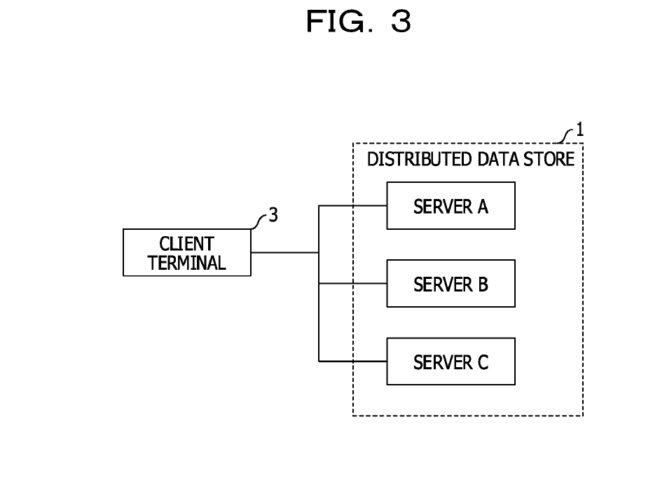

The present embodiment will be described in more detail below. FIG. 3 illustrates an outline of a system according to the present embodiment. A distributed data store 1 according to the present embodiment is implemented by the servers A to C. A client terminal 3 is coupled via a network to the servers A to C, and communication is performed between the client terminal 3 and the servers A to C. Each of the servers A to C communicates with another server. The network sometimes includes a wide area network (WAN) such as the Internet. In FIG. 3, the number of servers is three. However, there is no limitation on the number of servers.

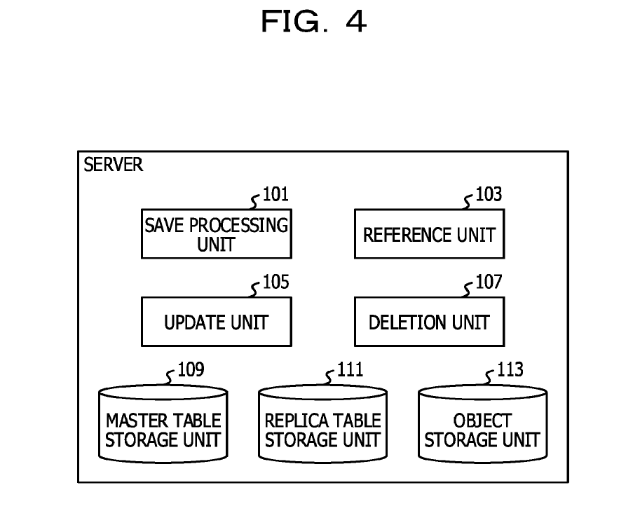

FIG. 4 illustrates a functional block diagram of a server. The server includes a save processing unit 101, a reference unit 103, an update unit 105, a deletion unit 107, a master table storage unit 109, a replica table storage unit 111, and an object storage unit 113.

The save processing unit 101 performs processing based on data stored in the master table storage unit 109 and, based on a processing result, updates data stored in the replica table storage unit 111. The save processing unit 101 saves an object to the object storage unit 113. The reference unit 103 performs processing based on data stored in the master table storage unit 109 and, based on a processing result, reads an object stored in the object storage unit 113 and transmits the object. The update unit 105 performs processing based on data stored in the master table storage unit 109 and, based on a processing result, updates data stored in the replica table storage unit 111. The update unit 105 updates an object stored in the object storage unit 113. The deletion unit 107 performs processing based on data stored in the master table storage unit 109. The deletion unit 107 deletes an object stored in the object storage unit 113.

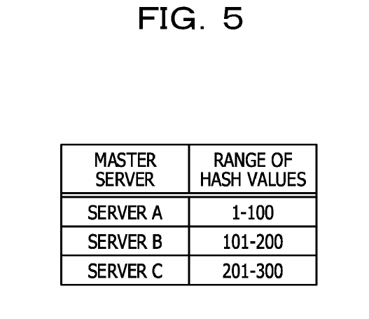

FIG. 5 depicts an example of a master table stored in the master table storage unit 109. In the examples of FIG. 5, the ID of a master server and a range of hash values computed from the ID of an object that the master server is to store are stored. The contents of master tables managed by the servers A to C are the same, and the contents of the master tables are set in advance by an administrator or the like. For example, when a server is added, when a server is deleted, when a server fails, or the like, the contents of master tables for the servers A to C are changed.

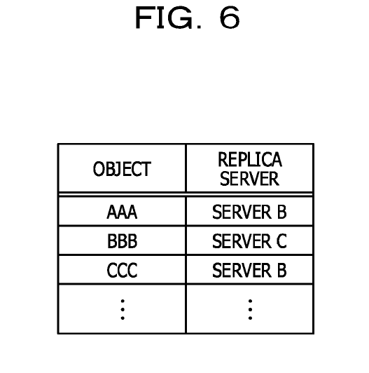

FIG. 6 depicts an example of a replica table stored in the replica table storage unit 111. In the example of FIG. 6, the IDs of objects and the IDs of replica servers for the objects are stored. In the example of FIG. 6, a server having the replica table illustrated in FIG. 6 stores the master of an object with an ID of AAA, the master of an object with an ID of BBB, and the master of an object with an ID of CCC. Then, the server B stores a replica of the object with the ID of AAA, the server C stores a replica of the object with the ID of BBB, and the server B stores a replica of the object with the ID of CCC.

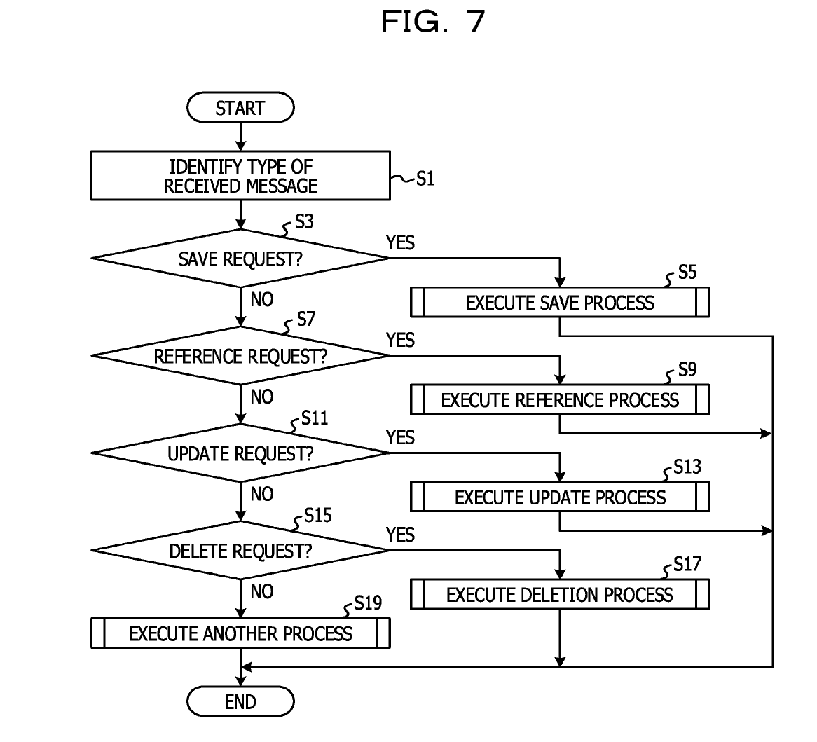

Next, in conjunction with FIG. 7 to FIG. 20, operations of a server in the present embodiment will be described. First, a server (which may be any of the servers A to C here) receives a message.

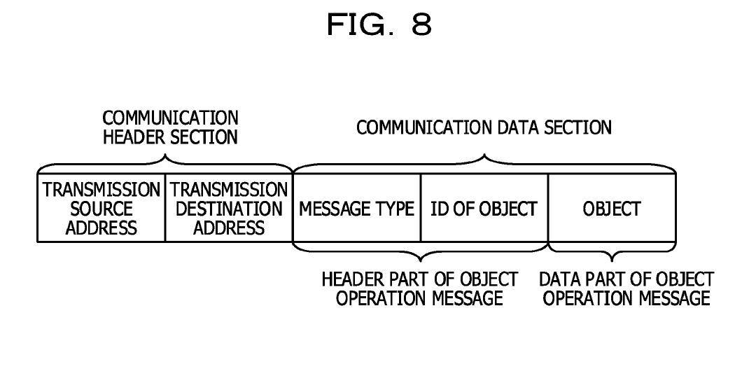

FIG. 8 depicts an example of a message. The message includes a communication header section and a communication data section. The communication header section includes a transmission source address and a transmission destination address. The communication data section includes a message type, the ID of an object, and the object. The communication data section is referred to as an object operation message. The object operation message includes a header part and a data part. The header part of the object operation message includes the message type and the object ID. The data part of the object operation message includes the object. On the occasion of transfer of a message, the transmission source address and the transmission destination address are replaced.

The server identifies the type of a message using a “message type” included in a received message (FIG. 7: S1) and determines whether the type of the received message is a save request (S3). The save request is a message requesting that an object be saved.

If it is determined that the type of the received message is a save request (S3: Yes route), the save processing unit 101 of the server executes a save process (S5). The save process will be described in detail below.

If it is determined that the type of the received message is not a save request (S3: No route), the server determines whether or not the type of the received message is a reference request (S7). The reference request is a message requesting that an object be referred to.

If it is determined that the type of the received message is a reference request (S7: Yes route), the reference unit 103 of the server executes a reference process (S9). The reference process will be described in detail below.

If it is determined that the type of the received message is not a reference request (S7: No route), the server determines whether or not the type of the received message is an update request (S11). The update request is a message requesting that an object be updated.

If it is determined that the type of the received message is an update request (S11: Yes route), the update unit 105 of the server executes an update process (S13). The update process will be described in detail below.

If it is determined that the type of the received message is not an update request (S11: No route), the server determines whether or not the type of the received message is a delete request (S15). The delete request is a message requesting that an object be deleted.

If it is determined that the type of the received message is a delete request (S15: Yes route), the deletion unit 107 of the server executes a deletion process (S17). The deletion process will be described in detail below.

If it is determined that the type of the received message is not a delete request (S15: No route), the server executes another process on the received message (S19). Then, the process is completed. The process executed in S19 is a process on a message that is not described in the present embodiment, and thus the detailed description thereof is omitted.

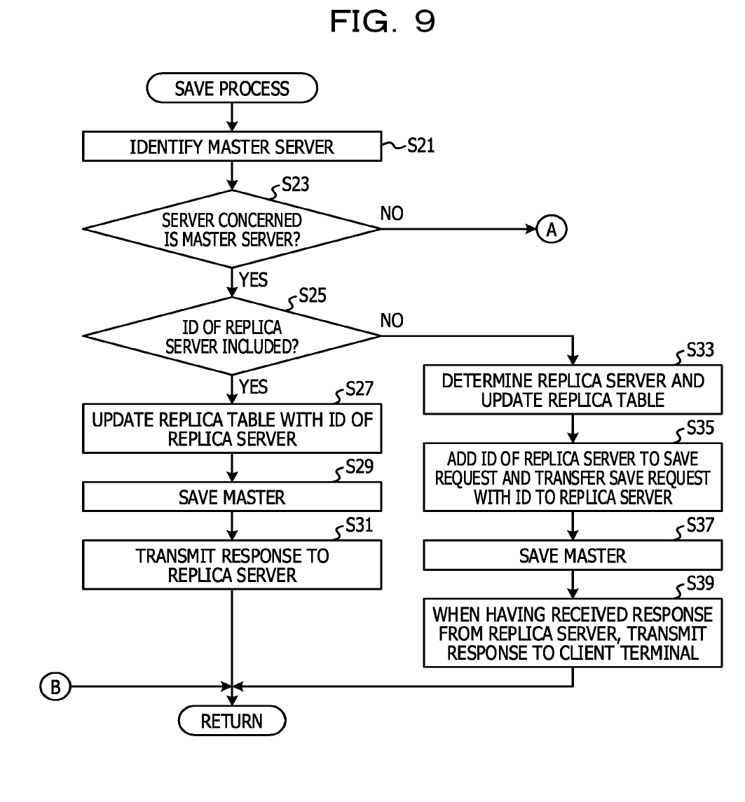

Next, the save process, the reference process, the update process, and the deletion process will be described. In conjunction with FIG. 9 to FIG. 11, the save process will be described first.

The save processing unit 101 of the server computes a hash value from the ID of an object included in the received save request and identifies a master server corresponding to the computed hash value from the master table storage unit 109 (FIG. 9: S21).

The save processing unit 101 determines whether or not the server concerned (that is, a server that executes this process) is a master server (S23). In S23, the save processing unit 101 determines whether or not the ID of the master server identified in S21 is the same as the ID of the server concerned.

If it is determined that the server concerned is the master server (S23: Yes route), the save processing unit 101 determines whether or not the received save request includes the ID of a replica server (S25).

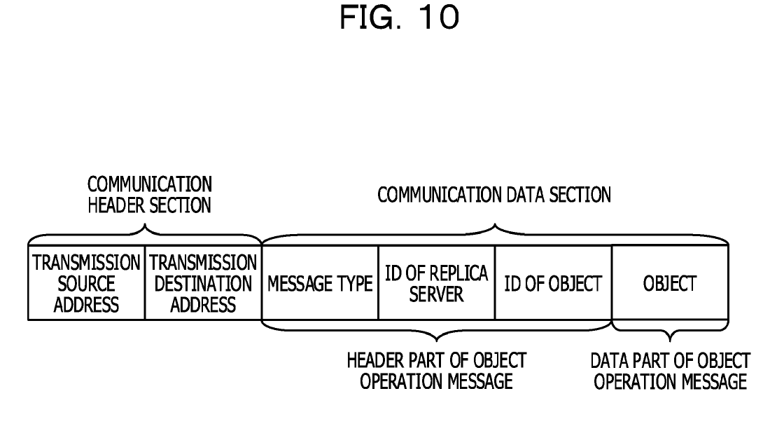

The ID of a replica server is not included in a message that the server receives from the client terminal 3 (for example, the message depicted in FIG. 8). However, in some of the messages exchanged between servers, the ID of a replica server is included as depicted in FIG. 10. The message depicted in FIG. 10 includes a communication header section and a communication data section. The communication header section includes a transmission source address and a transmission destination address. The communication data section includes a message type, the ID of a replica server, the ID of an object, and the object. The communication data section is referred to as an object operation message. The object operation message includes a header part and a data part. The header part of the object operation message includes the message type, the replica server ID, and the object ID. The data part of the object operation message includes the object.

If it is determined that the save request includes the ID of a replica server (S25: Yes route), the source of transmission of the save request is a replica server. Consequently, the save processing unit 101 updates a replica table stored in the replica table storage unit 111 with the ID of the replica server included in the save request (S27). In S27, an entry including the ID of the replica server and the object ID included in the save request are added to the replica table. In this way, in the replica table of a master server, an entry for a replica of an object saved to that master server is registered.

The save processing unit 101 stores the master of an object included in the save request in the object storage unit 113 (S29). Then, the save processing unit 101 transmits a response to the save request to the replica server serving as the source of transmission of the save request (S31).

On the other hand, if it is determined that the save request does not include the ID of a replica server (S25: No route), the source of transmission of the save request is the client terminal 3. Consequently, the save processing unit 101 determines a replica server for the object included in the save request in a given way and updates the replica table stored in the replica storage unit 111 (S33). In S33, the save processing unit 101 adds, to the replica table, an entry including the ID of the determined replica server and the object ID included in the save request. In this way, in the replica table of a master server, an entry for a replica of an object saved to that master server is registered.

The save processing unit 101 adds the ID of the determined replica server to the save request and transfers the save request with the ID to the replica server (S35). Then, the save processing unit 101 stores the master of the object included in the save request, in the object storage unit 113 (S37). Then, the save processing unit 101, when having received a response to the save request from the replica server, transmits the response to the save request to the client terminal 3 serving as the source of transmission of the save request (S39). Then, the process returns to the calling process.

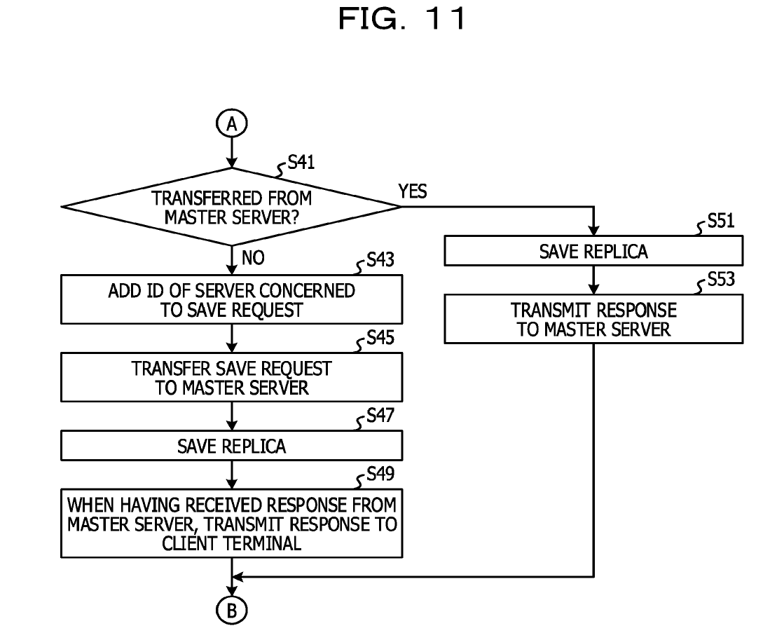

Meanwhile, if it is determined that the server concerned is not the master server (S23: No route), the process proceeds via a terminal A to S41 in FIG. 11.

The description will now be given with reference to FIG. 11. The save processing unit 101 determines whether or not the source of transmission of the save request is the master server (S41). In S41, the determination is made, for example, depending on whether or not the transmission source address included in the save request is the transmission source address of the master server identified in S21.

If it is determined that the source of transmission of the save request is not the master server (S41: No route), the source of transmission of the save request is the client terminal 3. Accordingly, the save processing unit 101 adds the ID of the server concerned to the save request (S43). Through the processing of S43, from the message depicted in FIG. 8, a message depicted in FIG. 10 is produced.

The save processing unit 101 transfers the save request to which the ID of the server concerned has been added in S43, to the master server identified in S21 (S45). This enables the master server to grasp which server is a replica server.

The save processing unit 101 stores a replica of the object included in the save request, in the storage unit 113 (S47).

The save processing unit 101, when having received, from the master server, a response to the save request, transmits the response to the save request to the client terminal 3 (S49). The process returns via a terminal B to the calling process.

On the other hand, if it is determined that the source of transmission of the save request is the master server (S41: Yes route), the server concerned is a replica server. Consequently, the save processing unit 101 stores a replica of the object included in the save request in the object storage unit 113 (S51).

The save processing unit 101 transmits a response to the save request to the master server (S53). The process returns via the terminal B to the calling process.

Once the process as described above is executed, if a server that has received a save request from the client terminal 3 is the master server, the master is saved to this server. On the other hand, if the server that has received a save request from the client terminal 3 is not the master server, a replica is saved to this server. In this way, transfer to both the master and the replica does not have to be carried out. This may reduce traffic between servers in the distributed data store 1.

Accordingly, according to the present embodiment, the number of times transfer is carried out may be decreased by one, regardless of the number of replicas. Accordingly, a decrease in the number of replicas produces an increase in the traffic reduction effect.

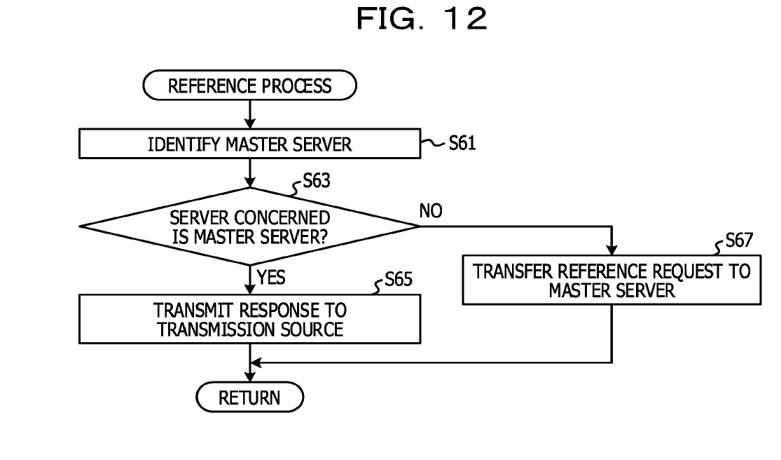

In conjunction with FIG. 12, the reference process will be described next.

First, the reference unit 103 of the server computes a hash value from an object ID included in a received reference request. Then, the reference unit 103 identifies, from the master table storage unit 109, a master server corresponding to the computed hash value (FIG. 12: S61). Nothing is included in the object field of the reference request.

The reference unit 103 determines whether the server concerned (that is, a server that executes this process) is the master server (S63). In S63, the reference unit 103 determines whether or not the ID of the master server identified in S61 is the same as the ID of the server concerned.

If it is determined that the server concerned is the master server (S63: Yes route), the reference unit 103 reads an object identified by the object ID included in the reference request from the object storage unit 113 and transmits a response including the read object to the source of transmission of the reference request (S65). Then, the process returns to the calling process. The source of transmission of the reference request is the client terminal 3 or another server.

On the other hand, if it is determined that the server concerned is not the master server (S63: No route), the reference unit 103 transfers the reference request to the master server identified in S61 (S67). Then, the process returns to the calling process.

Once the process as described above is executed, a reference request received from the client terminal 3 may be processed appropriately. In the reference process, since the details of the master are referred to, the details of the replica are not referred to. Consequently, when a replica server receives a reference request in a situation where the master is updated and the replica is not updated, the details before being updated are inhibited from being transmitted.

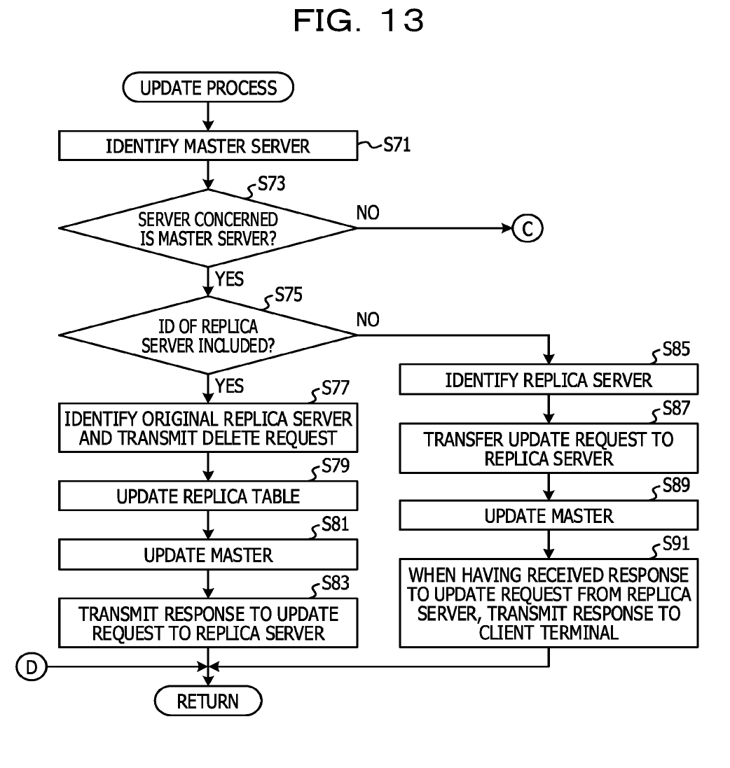

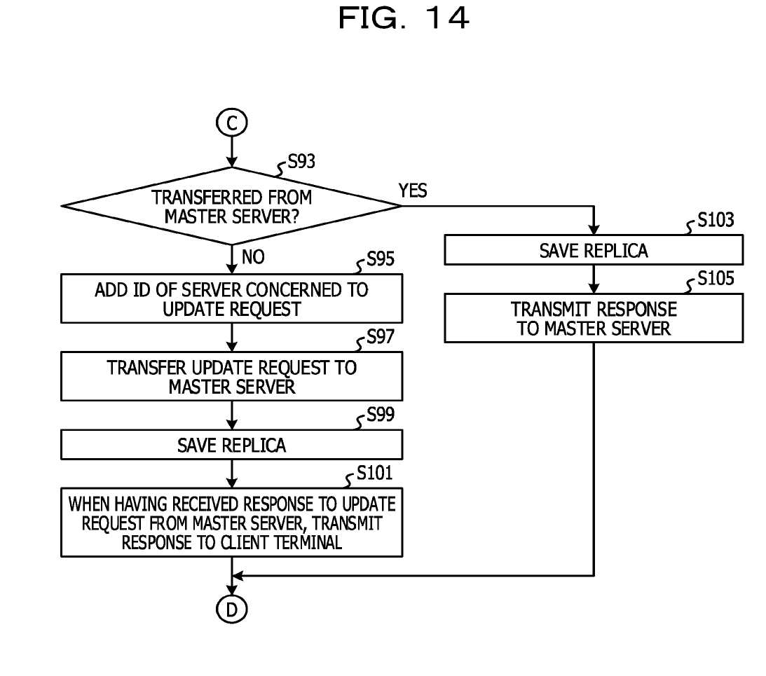

In conjunction with FIG. 13 and FIG. 14, the update process will be described next.

First, the update unit 105 of the server computes a hash value from an object ID included in a received update request. Then, the update unit 105 of the server identifies a master server corresponding to the computed hash value, from the master table storage unit 109 (FIG. 13: S71).

The update unit 105 determines whether or not the server concerned (that is, a server that executes this process) is the master server (S73). In S73, the update unit 105 determines whether or not the ID of the master server identified in S71 is the same as the ID of the server concerned.

If it is determined that the server concerned is the master server (S73: Yes route), the update unit 105 determines whether or not the received update request includes the ID of a replica server (S75). A message including a replica server ID is, for example, a message depicted in FIG. 10.

If it is determined that the update request includes the replica server ID (S75: Yes route), the source of transmission of the update request is a replica server that newly stores a replica of the object included in the update request. Consequently, the update unit 105 identifies a replica server corresponding to an object ID included in the update request. The replica server identified here is an original replica server (that is, a server that stores a replica before update). Then, the update unit 105 transmits, to the original replica server, a delete request including the object ID included in the update request (S77). In response to this, the original replica server deletes an object corresponding to the object ID included in the delete request, from the object storage unit 113. Thus, the object before being updated is no longer left within the distributed data store 1.

In the case where the original replica server and the replica server that newly stores a replica of the object after the update are the same, processing of S77 is omitted.

The update unit 105 updates the replica table stored in the replica table storage unit 111 with the replica server ID included in the update request (S79). In S79, the ID of a replica server corresponding to the object ID stored in the replica table and included in the update request is changed to the ID of the replica server included in the update request. In this way, in the replica table of the master server, an entry for a replica server that newly stores a replica of an object after update is registered.

The update unit 105 updates the master of the object stored in the object storage unit 113 with the object included in the update request (S81). Then, the update unit 105 transmits a response to the update request to a replica server that is the source of transmission of the update request (S83).

On the other hand, if it is determined that the update request does not include the ID of a replica server (S75: No route), the source of transmission of the update request is the client terminal 3. Consequently, the update unit 105 identifies a replica server corresponding to an object ID included in the update request, from the replica table stored in the replica table storage unit 111 (S85).

The update unit 105 transfers the update request to the replica server identified in S85 (S87). Then, the update unit 105 updates the master stored in the object storage unit 113 with the object included in the update request (S89).

The update unit 105, when having received a response to the update request from the replica server identified in S85, transmits the response to the update request to the client terminal 3 (S91). Then, the process returns to the calling process.

Meanwhile, if the server concerned is not the master server (S73: No route), the process proceeds via a terminal C to S93 in FIG. 14.

The description will now be given with reference to FIG. 14. The update unit 105 determines whether or not the source of transmission of the update request is the master server (S93). In S93, for example, the determination is made depending on whether or not the transmission source address included in the update request is the transmission source address of the master server identified in S71.

If it is determined that the source of transmission of the update request is not the maser server (S93: No route), the source of transmission of the update request is the client terminal 3. Consequently, the update unit 105 adds the ID of the server concerned to the update request (S95). Through processing of S95, from the message depicted in FIG. 8, the message depicted in FIG. 10 is produced.

The update unit 105 transfers the update request to which the ID of the server concerned has been added in S95, to the master server identified in S71 (S97). This enables the master server to grasp which server is a replica server storing a replica of the object after update.

The update unit 105 stores a replica of the object included in the update request to the object storage unit 113 (S99). When the server concerned is the original replica server, a replica is already stored in the object storage unit 113. Then, the update unit 105 updates that replica with the replica of the object included in the update request.

The update unit 105, when having received, from the master server, a response to the update request, transmits the response to the update request to the client terminal 3 (S101). The process returns via a terminal D to the calling process.

On the other hand, if it is determined that the source of transmission of the update request is the master server (S93: Yes route), the server concerned is a replica server. Consequently, the update unit 105 updates a replica stored in the object storage unit 113 with an object included in the update request (S103).

The update unit 105 transmits a response to the update request to the master server (S105). The process returns via the terminal D to the calling process.

Once the process as described above is executed, if a server that has received an update request from the client terminal 3 is a master server, the master stored in that server is updated, whereas if the server that has received an update request from the client terminal 3 is not a master server, a replica of the object after update is saved to the server. Even when an object is updated, transfer both to the master and the replica does not have to be carried out. This may reduce traffic between servers in the distributed data store 1.

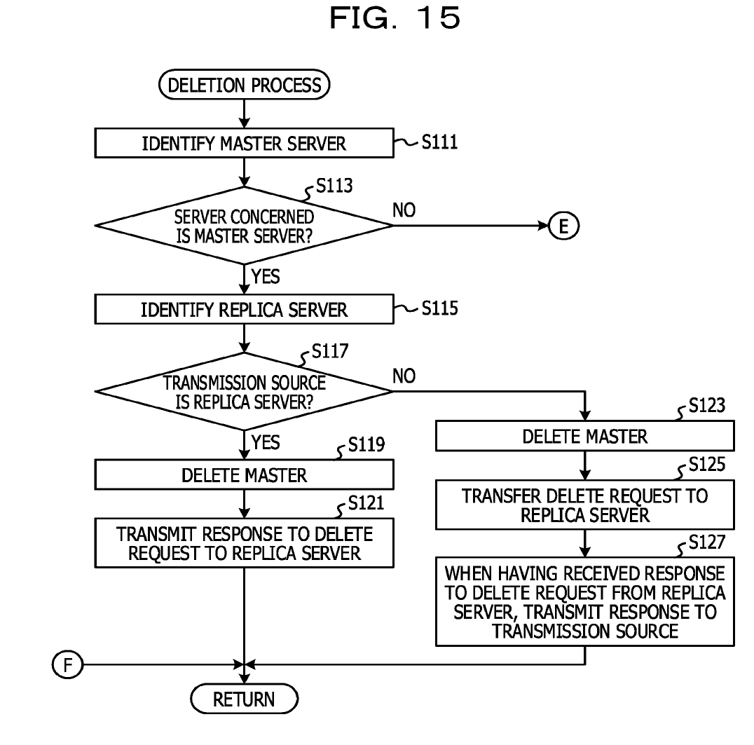

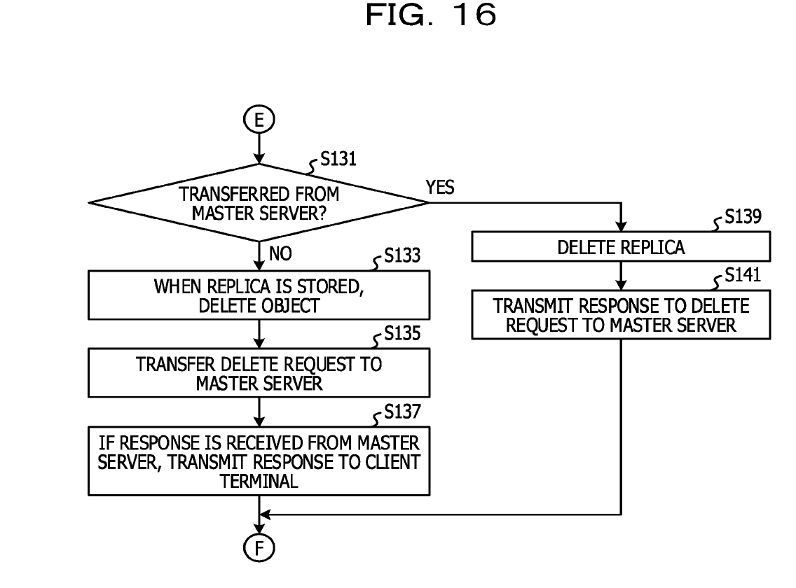

With reference to FIG. 15 to FIG. 16, the deletion process will be described next.

First, the deletion unit 107 of the server computes a hash value from an object ID included in the received delete request. Then, the deletion unit 107 identifies a master server corresponding to the computed hash value from the master table storage unit 109 (FIG. 15: S111). Nothing is included in the object field of the delete request.

The deletion unit 107 determines whether or not the server concerned (that is, a server that executes this process) is the master server (S113). In S113, the deletion unit 107 determines whether or not the ID of the master server identified in S111 is the same as the ID of the server concerned.

If it is determined that the server concerned is the master server (S113: Yes route), the deletion unit 107 identifies a replica server corresponding to the object ID included in the received delete request, from the replica table stored in the replica table storage unit 111 (S115).

The deletion unit 107 determines whether or not the source of transmission of the deletion request is a replica server (S117). In S117, the deletion unit 107 makes the determination depending on whether or not the address of the replica server identified in S115 is the same as the transmission source address included in the delete request.

If it is determined that the source of transmission of the delete request is a replica server (S117: Yes route), the deletion unit 107 deletes the master of an object identified by the object ID included in the deletion request, from the object storage unit 113 (S119).

The deletion unit 107 transmits a response to the delete request to the replica server (S121). The deletion unit 107 deletes an entry including the object ID included in the delete request, from the replica table in the replica table storage unit 111. Then, the process returns to the calling process.

On the other hand, if it is determined that the source of transmission of the delete request is not a replica server (S117: No route), the source of transmission of the delete request is a server other than the replica server, or the client terminal 3. The deletion unit 107 deletes the master of the object identified by the object ID included in the delete request, from the object storage unit 113 (S123).

The deletion unit 107 transfers the deletion request to the replica server (S125). Then, the deletion unit 107, when having received a response to the delete request from the replica server, transmits the response to the deletion request to the source of transmission of the delete request (S127). The deletion unit 107 deletes an entry including the object ID included in the delete request, from the replica table in the replica table storage unit 111. Then, the process returns to the calling process.

Meanwhile, if it is determined that the server concerned is not the master server (S113: No route), the process proceeds via a terminal E to S131 in FIG. 16.

The description will now be given with reference to FIG. 16. The deletion unit 107 determines whether or not the source of transmission of the delete request is the master server (S131). In S131, for example, the determination is made depending on whether or not the transmission source address included in the delete request is the transmission source address of the master server identified in S111.

If it is determined that the source of transmission of the delete request is not the master server (S131: No route), the source of transmission of the delete request is the client terminal 3. Consequently, if the server concerned stores a replica of the object identified by the object ID included in the delete request, the deletion unit 107 deletes the object (S133). If the server concerned is not a replica server, a replica of the object is not stored in the server concerned.

The deletion unit 107 transfers the delete request to the master server identified in S111 (S135). This enables the master server to delete the master of the object.

If a response to the delete request is received from the master server, the delete unit 107 transmits the response to the delete request to the client terminal 3 (S137). The process returns via a terminal F to the calling process.

On the other hand, if it is determined that the source of transmission of the delete request is the master server (S131: Yes route), the server concerned is a replica server. Consequently, the deletion unit 107 deletes a replica of the object identified by the object ID included in the delete request, from the object storage unit 113 (S139).

The deletion unit 107 transmits a response to the delete request to the master server (S141). The process returns via the terminal F to the calling process.

Once the process as described above is executed, both the master and the replica are deleted from the distributed data store 1.

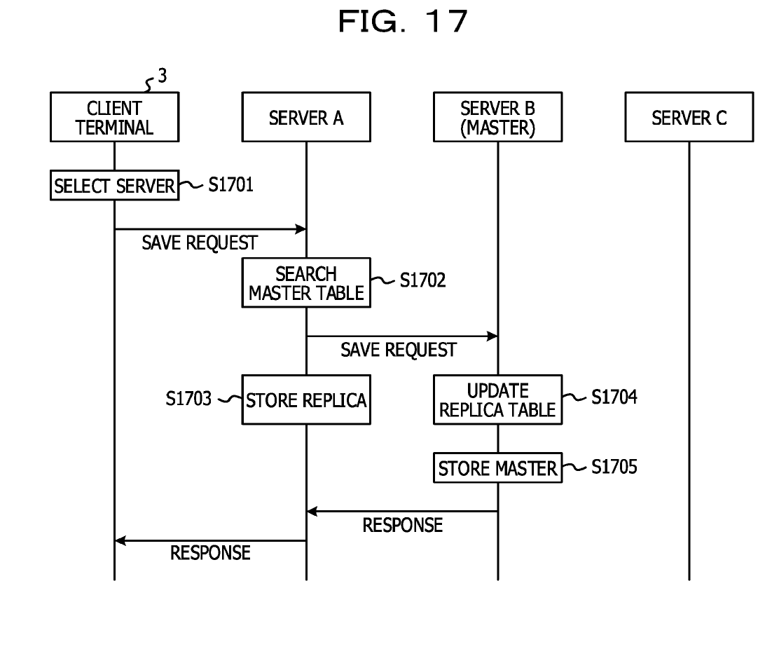

Next, in conjunction with FIG. 17 to FIG. 20, the processes described above will be more specifically described.

In conjunction with FIG. 17, processing for a save request will be described more specifically. The client terminal 3 selects a server serving as the destination of transmission of a save request, for example, using a round robin technique (S1701). Here, it is assumed that the transmission destination is the server A. The client terminal 3 transmits the save request to the server A.

The server A receives the save request from the client terminal 3. Then, the server A searches the master table and identifies a master server (S1702). Here, it is assumed that the server B is the master server. The server A transfers the save request with the ID of the server A added, to the server B. The server A stores a replica of an object included in the save request (S1703).

The server B serving as the master server receives the save request from the server A. Then, the server B updates the replica table with the ID of the server A included in the save request (S1704), and stores the master of the object included in the save request (S1705). Then, the server B transmits a response to the server A. The server A transmits the response to the client terminal 3.

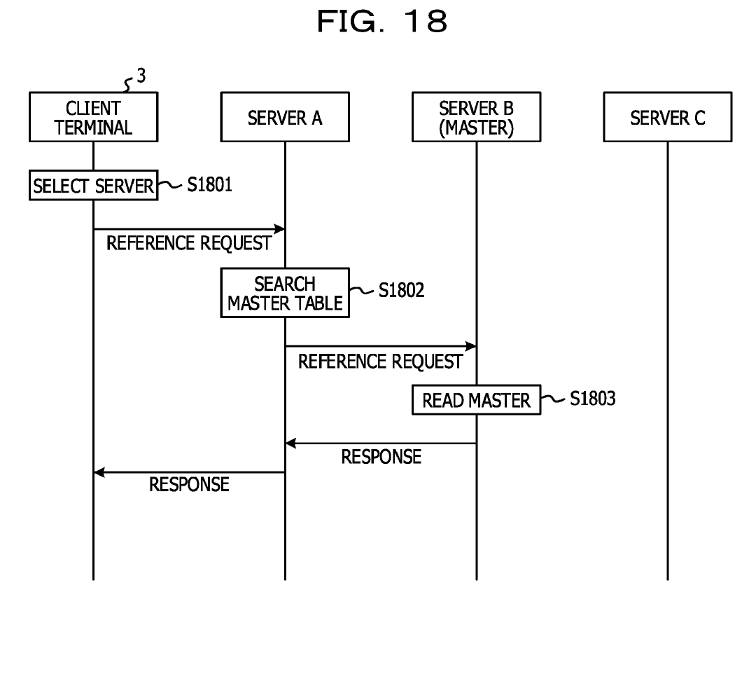

In conjunction with FIG. 18, processing for a reference request will be described more specifically. The client terminal 3 selects a server serving as the destination of transmission of a reference request, for example, using a round robin technique (S1801). Here, it is assumed that the transmission destination is the server A. The client terminal 3 transmits the reference request to the server A.

The server A receives the reference request from the client terminal 3. Then, the server A searches the master table and identifies a master server (S1802). Here, it is assumed that the server B is the master server. The server A transfers the reference request to the server B.

The server B serving as the master server receives the reference request from the server A. Then, the server B reads an object from the object storage unit 113 (S1803). Then, the server B transmits a response including the read object to the server A. The server A transmits the response to the client terminal 3.

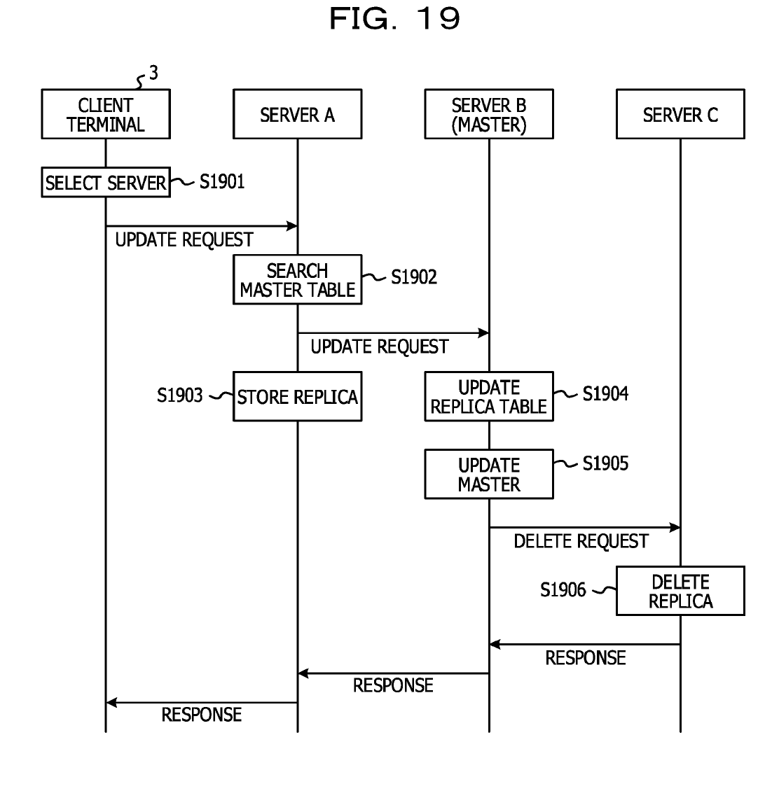

In conjunction with FIG. 19, processing for an update request will be described more specifically. The client terminal 3 selects a server serving as the destination of transmission of an update request, for example, using a round robin technique (S1901). Here, it is assumed the transmission destination is the server A. The client terminal 3 transmits the update request to the server A.

The server A receives the update request from the client terminal 3. Then, the server A searches the master table and identifies a master server (S1902). Here, it is assumed that the server B is the master server. The server A transfers the update request with the ID of the server A added, to the server B. In the server A, a replica of an object included in the update request is stored (S1903).

The server B serving as the master server receives the update request from the server A. Then, the server B updates the replica table with the ID of the server A included in the update request (S1904) and, based on the update request, updates the master (S1905). Then, the server B transmits a delete request to the server C, which is the original replica server.

The server C, which is the original replica server, receives the delete request from the server B. Then, the server C deletes an object from the object storage unit 113 (S1906). Then, the server C transmits a response to the server B. The server B transmits the response to the server A. The server A transmits the response to the client terminal 3.

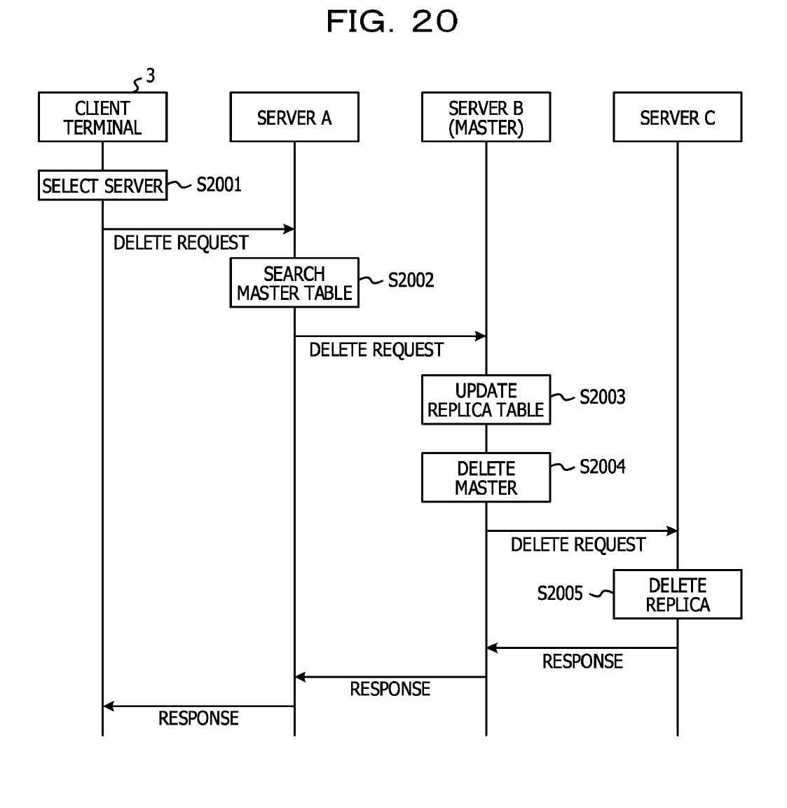

In conjunction with FIG. 20, processing for a delete request will be described more specifically. The client terminal 3 selects a server serving as the destination of transmission of a delete request, for example, using a round robin technique (S2001). Here, it is assumed that the transmission destination is the server A. The client terminal 3 transmits the delete request to the server A.

The server A receives the delete request from the client terminal 3. Then, the server A searches the master table and identifies the master server (S2002). Here, it is assumed that the server B is the master server. The server A transfers the delete request to the server B.

The server B, which is the master server, receives the delete request from the server A. Then, the server B deletes, from the replica table, an entry including the ID of an object to be deleted (S2003) and deletes the master based on the delete request (S2004). Then, the server B transfers the delete request to the server C serving as a replica server.

The server C serving as a replica server receives the delete request from the server B. Then, the server C deletes a replica based on the delete request (S2005). Then, the server C transmits a response to the server B. The server B transmits the response to the server A. The server A transmits the response to the client terminal 3.

One embodiment of the present disclosure has been described above; however, the present disclosure is not limited to this. For example, the functional block configuration of the servers A to C described above sometimes does not match the actual program module configuration.

The configuration of each table described above is exemplary, and the table does not have to have a configuration as described above. Furthermore, in the processing flow, the order in which processes are executed may be altered if the process results are not changed. Furthermore, the processes may be performed in parallel.

The example in which the number of replicas is one has been described in the above; however, the present embodiment may be applied to the case where the number of replicas is two or more.

In the reference process, a replica of the replica server is not referred to; however, the replica of the replica server may be referred to. Thus, when a server that has received a reference request is a replica server, the reference request does not have to be transferred. This decreases the time taken until a response is transmitted to the client terminal 3.

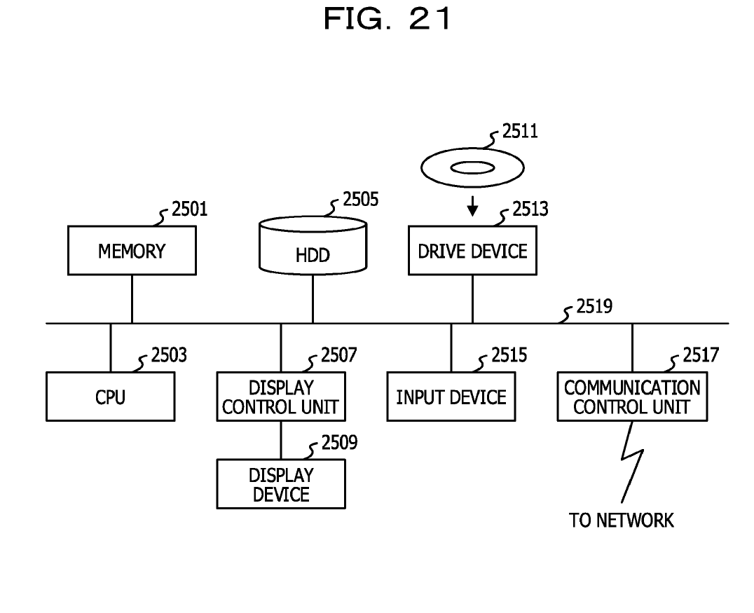

The servers A to C and the client terminal 3 described above are computer devices in which, as illustrated in FIG. 21, a memory 2501, a central processing unit (CPU) 2503, a hard disk drive (HDD) 2505, a display control unit 2507 coupled to a display device 2509, a drive device 2513 for a removable disk 2511, an input device 2515, and a communication control unit 2517 for coupling to a network are coupled by a bus 2519. An operating system (OS) and application programs for executing processes in the present embodiment are stored in the HDD 2505 and, when executed by the CPU 2503, are read from the HDD 2505 to the memory 2501. The CPU 2503 controls the display control unit 2507, the communication control unit 2517, the drive device 2513 in accordance with the details of processing of the application programs, so that the display control unit 2507, the communication control unit 2517, and the drive device 2513 perform given operations. Data being processed is stored mainly in the memory 2501 but may be stored in the HDD 2505. In the embodiment of the present disclosure, the application programs for executing the processes described above are distributed in such a manner as to be stored on the computer-readable removal disk 2511 and are installed from the drive device 2513 to the HDD 2505. The application programs are sometimes installed through a network such as the Internet and the communication control unit 2517 in the HDD 2505. In such a computer device, hardware, such as the CPU 2503 and the memory 2501 described above, and programs, such as the OS and application programs, cooperate organically. Thus, the computer device implements various functions as described above.

The embodiment of the present disclosure described above is summarized as follows.

An information processing apparatus according to a first aspect of the present embodiment includes (A) a first information storage unit that stores information for identifying a destination for saving data, (B) a save processing unit that, using information stored in the first information storage unit, identifies the destination for saving first data received from a terminal and determines whether or not the destination for saving the first data is the information processing apparatus. If the destination for saving the first data is the information processing apparatus, the save processing unit stores the first data, determines a second information processing apparatus serving as a destination for saving a replica of the first data in a given way, and transmits the replica to the second information processing apparatus. If the destination for saving the first data is a third information processing apparatus different from the information processing apparatus, the save processing unit transmits the first data to the third information processing apparatus and stores a replica of the first data.

Thus, the number of times data is transferred between information processing apparatuses is one. This may reduce the amount of communication data within the distributed data store.

The above-described destination for saving first data may be the information processing apparatus concerned. The save processing unit described above (b1) may store an identifier of the first data and an identifier of the second information processing apparatus in association with each other in a second information storage unit. Thus, when processing (for example, update) has been later performed on data, the destination for saving a replica of data may be notified that processing has been performed on data.

The above-described destination for saving first data may be a third information processing apparatus. The save processing unit described above (b2) may add an identifier of the information processing apparatus concerned to the first data and transmit the first data with the identifier to the third information processing apparatus. Thus, an information processing apparatus serving as the destination for saving data may be identified later. As a result, when processing (for example, update) is performed on data, the same processing may be performed on a replica.

This information processing apparatus may further include (C) an update unit that, when having received from a terminal a first update request requesting that the first data be updated, updates the first data, transfers the first update request to the second information processing apparatus, and that, when having received the first update request from a fourth information processing apparatus different from the second information processing apparatus, changes an identifier of the second information processing apparatus associated with the identifier of the first data in the second information storage unit, to an identifier of the fourth information processing apparatus, and transmits, to the second information processing apparatus, a first delete request requesting that the first data be deleted. Thus, when an information processing apparatus, having received an update request, stores data specified in the update request, the data and a replica of the data may be appropriately updated.

The above-described update unit, (c1) when having received from a terminal a second update request requesting that second data not stored in the information processing apparatus concerned be updated, may store a replica of the second data, identify a fifth information processing apparatus serving as the destination for saving the second data, using the first information storage unit, and transmit the second data and an identifier of the information processing apparatus concerned to the fifth information processing apparatus, and (c2), when having received the second update request from the fifth information processing apparatus, update the stored replica of the second data. Thus, when an information processing apparatus, having received an update request, does not store data specified in the update request, the data and a replica of the data may be appropriately updated.

This information processing apparatus may further include (D) a deletion unit that, when having received a first delete request from a sixth information processing apparatus different from the second information processing apparatus or the terminal, deletes the first data and transfers the first delete request to the second information processing apparatus. Thus, when an information processing apparatus, having received a delete request, stores data specified in the delete request, the data and a replica of the data may be appropriately deleted.

The above-described deletion unit, (d1) when having received from a terminal a second delete request requesting that the second data be deleted, may delete a replica of the second data and transfer the second delete request to the fifth information processing apparatus. Thus, when an information processing apparatus, having received a deletion request, does not store data specified in the delete request, the data and a replica of the data may be appropriately deleted.

This information processing apparatus may further include (E) a reference unit that, when having received a first reference request requesting that the first data be referred to, reads the first data and transmits a response to the first reference request to the source of transmission of the first reference request, and that, when having received a second reference request requesting that the second data be referred to, transfers the second reference request to the fifth information processing apparatus. Thus, the data and a replica of the data may be appropriately referred to.

The above-described information for identifying the destination for saving data may include a hash value and an identifier of an information processing apparatus serving as the destination for saving data with a hash value computed from the identifier being the same as that hash value. Thus, data may be appropriately distributed.

A data save method according to a second aspect of the present embodiment includes (F) using information stored in a first information storage unit that stores information for identifying a destination for saving data, identifying a destination for saving first data received from a terminal and determining whether or not the destination for saving the first data is a computer, (G) if the destination for saving the first data is the computer, storing the first data, determining, in a given way, a second computer serving as a destination for saving a replica of the first data, and transmitting the replica to the second computer, and, (H) if the destination for saving the first data is a third computer different from the computer, transmitting the first data to the third computer and storing the replica of the first data.

A program for causing a computer to execute a process by the above-mentioned method may be created, and the program is stored, for example, on a computer-readable storage medium such as a flexible disk, a compact disc read-only memory (CD-ROM), a magneto-optical disc, a semiconductor memory, or a hard disk, or a storage device. Note that intermediate processing results are temporarily stored in a storage device such as main memory.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing apparatus coupled to a plurality of computers, the information processing apparatus comprising:
a memory; and
a processor coupled to the memory and configured to:
receive first data from a client device;
determine whether the information processing apparatus is a master device that is to store the first data, by referring to assignment information indicating a correspondence relationship between a range of a hash value and a storage destination, using a hash value of the first data computed from an identifier of the first data as a key;
store the first data when it is determined that the information processing apparatus is the master device;
identify a replica device that is to store a replica of the first data from among the plurality of computers;
transmit the replica of the first data to the identified replica device;
identify a first information processing device used as the master device from among the plurality of computers, when it is determined that the information processing apparatus is not the master device;
transmit the first data to the identified first information processing device; and
store the replica of the first data.

2. The information processing apparatus according to claim 1, wherein the processor is configured to identify the replica device and the first information processing device based on the hash value of the first data and the assignment information.

3. The information processing apparatus according to claim 1, wherein the processor is configured to
store the identifier of the first data and an identifier of the replica device in association with each other.

4. The information processing apparatus according to claim 1,
wherein the processor is configured to add an identifier of the information processing apparatus to the first data and transmit the first data with the identifier to the first information processing device.

5. The information processing apparatus according to claim 3, wherein the processor is configured to:
update the first data when a first update request requesting that the first data be updated is received from the client device;
transfer the first update request to the replica device;
change the identifier of the replica device stored in association with the identifier of the first data to an identifier of a second information processing device among the plurality of computers, the second information processing device being different from the replica device, when the first update request is received from the second information processing device; and
transmit a first delete request requesting that the first data be deleted to the replica device.

6. The information processing apparatus according to claim 5, wherein the processor is configured to:
store a replica of the second data when a second update request requesting that second data not stored in the information processing apparatus be updated is received from the client device;
identify a third information processing device storing the second data from among the plurality of computers, based on a hash value computed from an identifier of the second data and the assignment information;
transmit the second data and an identifier of the information processing apparatus to the third information processing device; and
update the stored replica of the second data when the second update request is received from the third information processing device.

7. The information processing apparatus according to claim 6, wherein the processor is configured to:
delete the first data when the first delete request is received from a fourth information processing device among the client device and the plurality of computers, the fourth information processing device being different from the replica device; and
transfer the first delete request to the replica device.

8. The information processing apparatus according to claim 7, wherein the processor is configured to:
delete the replica of the second data when a second delete request requesting that the second data be deleted is received from the client device; and
transfer the second delete request to the third information processing device.

9. The information processing apparatus according to claim 8, wherein the processor is configured to:
read the first data and transmit a response to a first reference request requesting that the first data be referred to, to a source of transmission of the first reference request, when the first reference request is received; and
transfer the first reference request to the third information processing device, when a second reference request requesting that the second data be referred to is received.

10. A data storage method executed by an information processing apparatus coupled to a plurality of computers, the data storage method comprising:
receiving first data from a client device;
determining whether the information processing apparatus is a master device that is to store the first data, by referring to assignment information indicating a correspondence relationship between a range of a hash value and a storage destination, using a hash value of the first data computed from an identifier of the first data as a key;
storing the first data when it is determined that the information processing apparatus is the master device;
identifying a replica device that is to store a replica of the first data from among the plurality of computers based on the hash value of the first data and the assignment information;
transmitting the replica of the first data to the identified replica device;
identifying a first information processing device used as the master device from among the plurality of computers based on the hash value of the first data and the assignment information, when it is determined that the information processing apparatus is not the master device;
transmitting the first data to the identified first information processing device; and
storing the replica of the first data.

11. The data storage method according to claim 10, further comprising
storing the identifier of the first data and an identifier of the replica device in association with each other.

12. The data storage method according to claim 10, wherein the transmitting of the first data includes:
adding an identifier of the information processing apparatus to the first data, and
transmitting the first data with the identifier to the first information processing device.

13. An information processing system, comprising:
a plurality of computers; and
an information processing apparatus coupled to the plurality of computers and configured to:
receive first data from a client device;
determine whether the information processing apparatus is a master device that is to store the first data, by referring to assignment information indicating a correspondence relationship between a range of a hash value and a storage destination, using a hash value of the first data computed from an identifier of the first data as a key;
store the first data when it is determined that the information processing apparatus is the master device;
identify a replica device that is to store a replica of the first data from among the plurality of computers based on the hash value of the first data and the assignment information;
transmit the replica of the first data to the identified replica device;
identify a first information processing device used as the master device from among the plurality of computers based on the hash value of the first data and the assignment information, when it is determined that the information processing apparatus is not the master device;
transmit the first data to the identified first information processing device; and
store the replica of the first data.
